(19) United States
(12) Patent Application Publication
(10) Pub. No.: US 2024/0422749 A1
(43) Pub. Date: Dec. 19, 2024

(54) RESOURCE EXCLUSION METHOD, TERMINAL DEVICE, AND STORAGE MEDIUM

(71) Applicant: GUANGDONG OPPO MOBILE TELECOMMUNICATIONS CORP., LTD., Dongguan (CN)

(72) Inventors: Yi DING, Dongguan (CN); Zhenshan ZHAO, Dongguan (CN)

(21) Appl. No.: 18/816,288

(22) Filed: Aug. 27, 2024

Related U.S. Application Data
(63) Continuation of application No. PCT/CN2022/085372, filed on Apr. 6, 2022.

(51) Int. Cl. H04W 72/0446

(52) U.S. Cl. CPC H04W 72/0446

(57) ABSTRACT

A resource exclusion method includes: performing, by a first module of a terminal device, resource exclusion according to a target resource, where the target resource is a transmission resource of a second module of the terminal device, and the first module and the second module are two different communication modules.

### CROSS-REFERENCE TO RELATED APPLICATION

This application is a Continuation Application of International Application No. PCT/CN2022/085372 filed Apr. 6, 2022, which is incorporated herein by reference in its entirety.

### TECHNICAL FIELD

The embodiments of the present application relate to the technical field of communications, and in particular to a resource exclusion method, a terminal device, and a storage medium.

### BACKGROUND

In Sidelink (SL) communications, a terminal device may select transmission resources from a resource pool by way of monitoring. At present, further research will be needed on a resource exclusion method in New Radio (NR) systems.

### SUMMARY

According to an aspect of embodiments of the present application, a resource exclusion method is provided. The method is applied to a terminal device, the terminal device includes a first module and a second module, and the method includes:
performing, by the first module, resource exclusion according to a target resource, where the target resource is a transmission resource of the second module, and the first module and the second module are two different communication modules.

According to an aspect of embodiments of the present application, a resource exclusion apparatus is provided. The apparatus includes a first module and a second module.

The first module is configured to perform resource exclusion according to a target resource, the target resource is a transmission resource of the second module, and the first module and the second module are two different communication modules.

According to an aspect of embodiments of the present application, a terminal device is provided. The terminal device includes a processor and a memory, where the memory stores a computer program thereon, and the processor executes the computer program to implement the above-mentioned resource exclusion method.

According to an aspect of embodiments of the present application, a non-transitory computer-readable storage medium is provided. The non-transitory storage medium stores a computer program thereon, and the computer program is used to be executed by a processor to implement the above-mentioned resource exclusion method.

According to an aspect of embodiments of the present application, a chip is provided. The chip includes a programmable logic circuitry and/or program instructions, and when the chip is operating, the chip is configured to implement the above-mentioned resource exclusion method.

According to an aspect of embodiments of the present application, a computer program product is provided. The computer program product includes computer instructions stored on a non-transitory computer-readable storage medium, and a processor reads and executes the computer instructions from the non-transitory computer-readable storage medium to implement the above-mentioned resource exclusion method.

### BRIEF DESCRIPTION OF THE DRAWINGS

FIG. 1 is a schematic diagram of a network architecture provided by an embodiment of the present application;

FIGS. 2A and 2B are schematic diagrams illustrating two types of transmission modes provided by an embodiment of the present application;

FIG. 3 is a schematic diagram illustrating a NR V2X physical layer structure provided by an embodiment of the present application;

FIG. 4 is a schematic diagram illustrating time-frequency resource location reservation provided by an embodiment of the present application;

FIGS. 5A and 5B are schematic diagrams illustrating resource sensing and resource selection provided by an embodiment of the present application;

FIG. 6 is a schematic diagram illustrating a LTE V2X physical layer structure provided by an embodiment of the present application;

FIG. 7 is a flow chart of a resource exclusion method provided by an embodiment of the present application;

FIG. 8 is a flow chart of a resource exclusion method provided by another embodiment of the present application;

FIG. 9 is a flow chart of a resource exclusion method provided by still another embodiment of the present application;

FIG. 10 is a flow chart of a resource exclusion method provided by still another embodiment of the present application;

FIG. 11 is a block diagram of a resource exclusion apparatus provided by an embodiment of the present application; and

FIG. 12 is a schematic structural diagram of a terminal device provided by an embodiment of the present application.

### DETAILED DESCRIPTION

In order to make the objectives, technical solutions, and advantages of the present application clear, implementations of the present application will be further described in detail with reference to the drawings.

Network architectures and service scenarios described in the embodiments of the present application are intended to describe technical solutions of the embodiments of the present application more clearly, but do not constitute any limitation on technical solutions provided in the embodiments of the present application. Those of ordinary skill in the art may know that as the network architecture evolves and new service scenarios emerge, the technical solutions provided in the embodiments of the present application are also applicable to similar technical problems.

The embodiments of the present application provide a resource exclusion method applied to a terminal device that includes a first module and a second module. The method includes:
performing, by the first module, resource exclusion according to a target resource, where the target resource is a transmission resource of the second module, and the first module and the second module are two different communication modules.

In some embodiments, the transmission resource of the second module is a selected resource of the second module; or the transmission resource of the second module is a scheduled resource of the second module.

In some embodiments, the target resource includes one or more resources.

In some other embodiments, the target resource includes one or more groups of periodic resources.

In some embodiments, the target resource is indicated to the first module by the second module.

In some embodiments, the target resource includes one or more groups of periodic resources, and the method further includes:
indicating, by the second module, one or more resources to the first module; and
determining, by the first module, the one or more groups of periodic resources according to the one or more resource indicated by the second module.

In some embodiments, the method further includes:
indicating, by the second module, a resource reservation period corresponding to the second module to the first module; and/or
indicating, by the second module, a quantity of periods of at least one resource to the first module, where the quantity of periods of the resource is used to determine a group of periodic resources corresponding to the resource.

In some embodiments, the target resource includes one or more groups of periodic resources, the method further includes:
indicating, by the second module, the one or more groups of periodic resources to the first module.

In some embodiments, the first module and the second module perform transmission on a same carrier.

In some embodiments, performing, by the first module, resource exclusion according to the target resource includes:
performing, by the first module, resource exclusion on a first resource set according to the target resource.

In some embodiments, the first resource set includes all available resources in a resource selection window; or the first resource set includes available resources in part of time units in a resource selection window.

In some embodiments, the first resource set includes remaining resources obtained after at least one resource exclusion step is performed on all the available resources in the resource selection window; or the first resource set includes remaining resources obtained after at least one resource exclusion step is performed on the available resources in part of time units in the resource selection window.

In some embodiments, the at least one resource exclusion step includes at least one of the following:
a first exclusion step used to perform resource exclusion according to monitored first sidelink control information;
a second exclusion step used to perform resource exclusion according to monitored second sidelink control information; or
a third exclusion step used to perform resource exclusion according to unmonitored time unit(s);
where the first sidelink control information and the second sidelink control information are two different pieces of sidelink control information.

In some embodiments, the first sidelink control information is sidelink control information monitored by the first module, and the second sidelink control information is sidelink control information monitored by the second module.

In some embodiments, performing, by the first module, resource exclusion on the first resource set according to the target resource includes:
for a first resource in the first resource set, in response that the first resource meets an exclusion condition, excluding, by the first module, the first resource from the first resource set, where the exclusion condition includes: the first resource or a periodic resource corresponding to the first resource overlapping with the target resource.

In some embodiments, the first resource or the periodic resource corresponding to the first resource overlapping with the target resource includes:
the first resource or the periodic resource corresponding to the first resource overlapping with any resource in the target resource; or the first resource or the periodic resource corresponding to the first resource overlapping with any group of periodic resources in the target resource.

In some embodiments, in a case where the first resource or the periodic resource corresponding to the first resource overlaps with any group of periodic resources in the target resource, the exclusion condition further includes: a quantity of resources overlapping being greater than or equal to a quantity threshold.

In some embodiments, the exclusion condition further includes: a priority level value of data transmission of the second module being less than a priority level value of data transmission of the first module and/or less than a priority level threshold.

In some embodiments, the priority level value of the data transmission of the second module is a priority level value of data transmitted by the second module on the target resource.

In some embodiments, the method further includes:
indicating, by the second module, the priority level value of data transmission of the second module to the first module.

In some embodiments, the periodic resource corresponding to the first resource includes: a periodic resource including the first resource, and having a same frequency-domain location as the first resource and different time-domain locations spaced with a resource reservation period corresponding to the first module as an interval.

In some embodiments, the first module is a new radio (NR) module, and the second module is a long term evolution (LTE) module or an evolved universal terrestrial radio access (E-UTRA) module.

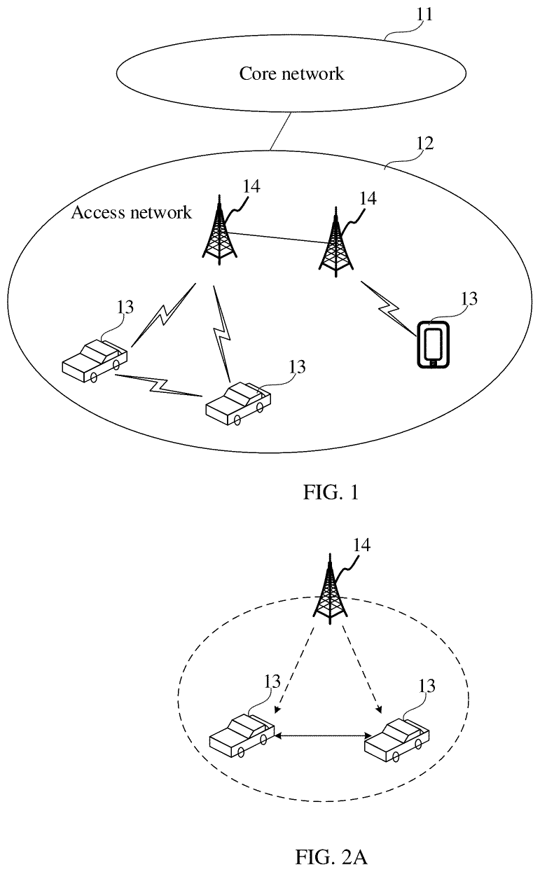

Reference is made to FIG. 1, which illustrates a schematic diagram of a network architecture, in accordance with an embodiment of the present application. The network architecture may include: a core network 11, an access network 12, and a terminal 13.

The core network 11 includes several core network devices. The core network device has functions of mainly providing user connection and user management, and completing bearing for service, and further functions as an interface to an external network provided by a bearer network. For example, a core network of a 5th generation (5G) new radio (NR) system may include an access and mobility management function (AMF) entity, a user plane function (UPF) entity, a session management function (SMF) entity.

The access network 12 includes several access network devices 14. The access network in the 5G NR system may be referred to as new generation radio access network (NG-RAN). The access network device 14 is a device that is deployed in the access network 12 and used to provide wireless communication functions for the terminal device 13. The access network device 14 may include various forms of macro base stations, micro base stations, relay stations, access points, etc. In systems employing different wireless access technologies, the devices with functions of the access network device may have different names. For example, in 5G NR systems, such devices are referred to as gNodeB or gNB. With the evolution of communication technologies, the name “access network device” may change. For convenience of description, in the embodiments of the present application, the apparatuses for providing wireless communication functions for the terminal device 13 as described above are collectively referred to as access network devices.

Generally, there are a plurality of terminal devices 13, and one or more terminal devices 13 may be distributed in a cell managed by each access network device 14. The terminal devices 13 may include various devices with the wireless communication functions, such as handheld devices, vehicle-mounted devices, wearable devices, computing devices, or other processing devices connected to wireless modems, or various forms of user equipments (UE), mobile stations (MS). For convenience of description, the above-mentioned devices are collectively referred to as terminal devices. The access network device 14 and the core network device communicate with each other based on a certain air technology, such as a NG interface in the 5G NR system. The access network device 14 and the terminal device 13 communicate with each other based on a certain air technology, such as a Uu interface.

Two terminal devices 13 (e.g., a vehicle-mounted device and another device such as another vehicle-mounted device, a mobile phone, or a road side unit (RSU)) may communicate with each other through a direct-connection communication interface (e.g., a PC5 interface), and accordingly, a communication link established based on the direct-connection communication interface may be referred to as a direct link or sidelink (SL). SL transmission is a direct communication of communication data between terminal devices through sidelink. Different from reception or transmission of the communication data through the access network device in a traditional cellular system, the SL transmission has characteristics of short delay, low overhead, etc., and is suitable for communication between two terminal devices that are geographically close to each other (such as a vehicle-mounted device and other peripheral devices that are geographically close thereto). It should be noted that in FIG. 1, considering vehicle to vehicle communication in a vehicle to everything (V2X) scenario as an example, SL technology may be applied to scenarios where various terminal devices communicate directly with each other. In other words, the terminal devices in the present application refer to any devices that utilize SL technology for communication.

The “5G NR system” in the embodiments of the present application may also be referred to as a 5G system or an NR system, and those skilled in the art can understand the meaning. The technical solutions described in the embodiments of the present application may be applied to the 5G NR system, and may also be applied to a subsequent evolution system of the 5G NR system. In the embodiments of the present application, terms “terminal equipment” and “UE” usually express the same meaning, and the two may be used interchangeably, and those skilled in the art can understood the meaning.

Before introducing the technical solutions of the present application, some background technical knowledge involved in the embodiments of the present application will be introduced and explained. The following relevant technologies, as optional solutions, can be arbitrarily combined with the technical solutions of the embodiments of the present application, and these combined solutions all fall within the protection scope of the embodiments of the present application. The embodiments of the present application include at least part of the following contents.

### 1. Sidelink (SL) Transmission

Device to device communication is a sidelink transmission technology, which is different from the way that communication data is received or sent through base stations in traditional cellular systems. For example, V2X systems have a high spectrum efficiency and low transmission delay due to the adoption of device-to-device direct communication. Regarding the SL transmission, 3rd Generation Partnership Project (3GPP) defines two transmission modes: Mode A and Mode B.

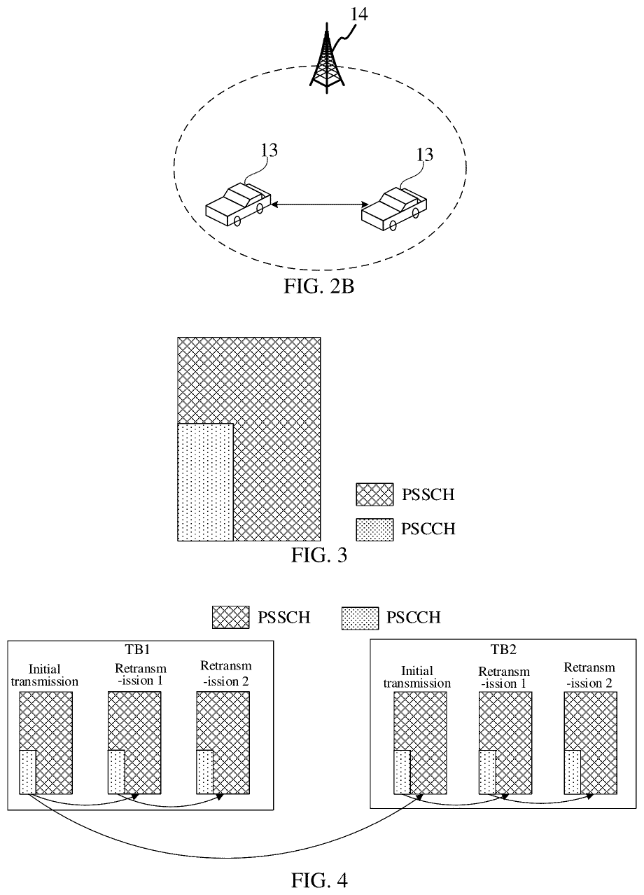

Mode A: as shown in FIG. 2A, transmission resources of a terminal device 13 are allocated by an access network device 14 (e.g. a base station), and the terminal device 13 transmits communication data through sidelink based on the transmission resources allocated by the access network device 14. The access network device 14 may allocate transmission resources for a single transmission to the terminal device 13, or may allocate transmission resources for semi-persistent transmission to the terminal device 13.

Mode B: as shown in FIG. 2B, the terminal device 13 autonomously selects transmission resources from a resource pool to transmit the communication data. Specifically, the terminal device 13 may select transmission resources from the resource pool by way of monitoring, or select transmission resources from the resource pool by way of random selecting.

The SL communication in an NR V2X system and a long term evaluation (LTE) V2X, as well as a method for a terminal device to autonomously select resource (i.e., the above Mode B) will be mainly described below.

### 2. NR V2X Physical Layer Structure

The physical layer structure of SL communication in the NR V2X system is shown in FIG. 3. A physical sidelink control channel (PSCCH) is used to carry first sidelink control information, and a physical sidelink shared channel (PSSCH) is used to carry data and third sidelink control information. The PSCCH and the PSSCH perform transmission in the same slot. The first sidelink control information and the third sidelink control information may be two pieces of sidelink control information having different uses. For example, the first sidelink control information is carried by the PSCCH, and mainly includes fields related to resource sensing, so as to facilitate resource exclusion and resource selection after decoding by other terminal devices. In addition to data, the PSSCH carries the third sidelink control information, which mainly includes fields related to data demodulation so as to facilitate demodulation for the data in the PSSCH by other terminal devices.

For example, the first sidelink control information is 1st-stage-SCI, i.e., the first-stage sidelink control information (SCI).

For example, the third sidelink control information is 2nd-stage-SCI, i.e., the second-stage SCI.

3. Resource reservation in NR V2X

In the NR V2X system, the terminal device in Mode B autonomously selects transmission resources to send data. Resource reservation is a prerequisite for resource selection.

The resource reservation refers to that the terminal device sends the first sidelink control information in the PSCCH to reserve resources to be used subsequently. In the NR V2X system, resource reservation within a transport block (TB) is supported, and resource reservation between TB s is also supported.

As shown in FIG. 4, the terminal device sends the first sidelink control information, in which a “Time resource assignment” field and a “Frequency resource assignment” field are used to indicate N time-frequency resources (including resources used for current transmission) in the current TB, where N≤Nmax, and in NR V2X, Nmax equals to 2 or 3. In addition, the indicated N time-frequency resources should be distributed in W slots. In NR V2X, W equals to 32. For example, in TB1 illustrated in FIG. 4, the terminal device sends the first sidelink control information in the PSCCH while sending data of initial transmission on the PSSCH, and the above mentioned two fields are used to indicate time-frequency resource locations for the initial transmission and retransmission 1 (that is, in this case, N=2); that is, time-frequency resources for the retransmission 1 are reserved. Moreover, the initial transmission and retransmission 1 are distributed within 32 slots in the time domain. Similarly, in TB1 illustrated in FIG. 4, the terminal device indicates time-frequency resource locations for retransmission 1 and retransmission 2 by using the first sidelink control information sent in the PSCCH of retransmission 1, and retransmission 1 and retransmission 2 are distributed within 32 slots in the time domain.

In the case where the terminal device sends the first sidelink control information, a “Resource reservation period” field is used for resource reservation between TBs. For example, in FIG. 4, in the case where the terminal devices sends the first sidelink control information for initial transmission of TB1, time-frequency resource locations for the initial transmission of TB1 and retransmission 1 of TB1 are indicated by using the “Time resource assignment” field and “Frequency resource assignment” field, and are denoted as {(t1, f1), (t2, f2)}, where t₁ and t₂ represent time domain locations of resources for the initial transmission and retransmission 1, and f₁ and f₂ represent corresponding frequency domain locations thereof. If the “Resource reservation period” field in the first sidelink control information has a value of 100 milliseconds, the SCI simultaneously indicates time-frequency resources {(t₁+100, f₁), (t₂+100, f₂)}, and these two resources are used for transmission of initial transmission and retransmission 1 in TB2. Similarly, in the first sidelink control information transmitted in retransmission 1 in TB1, the “Resource reservation period” field is also used to reserve time-frequency resources for retransmission 1 and retransmission 2 in TB2. In NR V2X, the “Resource reservation period” field has the possible values of 0 milliseconds, 1 to 99 milliseconds, 100 milliseconds, 200 milliseconds, 300 milliseconds, 400 milliseconds, 500 milliseconds, 600 milliseconds, 700 milliseconds, 800 milliseconds, 900 milliseconds and 1000 milliseconds, which is more flexible than LTE V2X. However, in each resource pool, only e values of the possible values are configured, and the terminal device determines the possible values according to the used resource pool. The e values of the possible values in the resource pool configuration constitute a resource reservation period set M. Exemplarily, e is less than or equal to 16.

In addition, by way of configuring by network or pre-configuring, the reservation between TBs may be activated or deactivated on per resource pool basis. When the reservation between TBs is activated, the first sidelink control information includes the “Resource reservation period” field. When the reservation between TBs is deactivated, the first sidelink control information does not include the “Resource reservation period” field. Generally, during activation of the reservation between TBs, before resource reselection is triggered, a value (i.e., a resource reservation period) of the “Resource reservation period” field used by the terminal device will not change. Every time the terminal device sends the first sidelink control information, the “Resource reservation period” field is configured to reserve resources for transmission of another TB in the next period, so as to achieve periodic semi-persistent transmission.

In the case where the terminal device operates in Mode B, the terminal device may obtain the first sidelink control information sent by other terminal devices by sensing PSCCHs sent by other terminal devices, so as to determine resources reserved by the other terminal devices. The terminal device will exclude the resources reserved by the other terminal devices when performing resource selection, so as to avoid resource collision.

### 4. Resource Selection Method for NR V2X Sensing

In the NR V2X system, the terminal device needs to autonomously select resource(s) in Mode B.

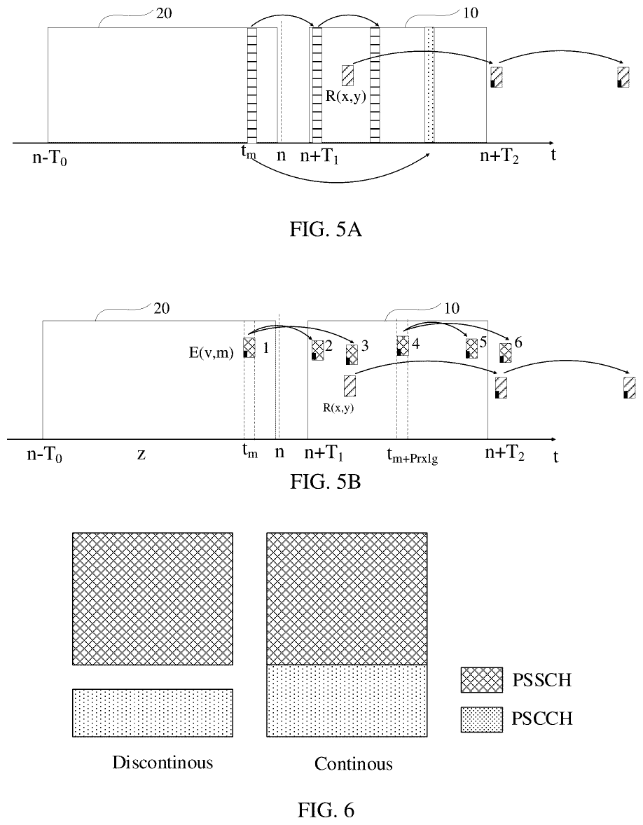

As shown in FIGS. 5A and 5B, the terminal device triggers resource selection or resource reselection in slot n, slot n being a slot where the higher layer triggers a physical layer to report a candidate resource set. A resource selection window 10 starts at n+T1 and ends at n+T₂, where 0≤T1≤T_{proc,1}, when a subcarrier interval is 15 kHz, 30 kHz, 60 kHz, or 120 kHz, T_{proc,1} is 3 slots, 5 slots, 9 slots, or 17 slots, respectively, and T₂ₘᵢₙ≤T₂≤a residual delay budget of service. A set of values of T₂ₘᵢₙ is {1, 5, 10, 20}×2^{μ} slots, and cases where u is equal to 0, 1, 2, or 3 correspond to the cases where the subcarrier interval is 15 kHz, 30 kHz, 60 kHz, or 120 kHz, respectively. The terminal device determines T₂ₘᵢₙ from the set of values according to a priority of data to be transmitted by the terminal device. For example, when the subcarrier interval is 15 kHz, the terminal device determines T₂ₘᵢₙ from a set {1, 5, 10, 20} according to the priority of the data to be transmitted by itself. When T₂ₘᵢₙ is greater than or equal to the residual delay budget of service, T₂ is equal to the residual delay budget of service. The residual delay budget is a difference between a moment corresponding to a data delay requirement and the current moment. For example, for a packet arriving at slot n, the delay requirement is 50 milliseconds. Assuming that a slot has a duration of 1 millisecond, if the current moment is slot n, the residual delay budget is 50 ms; if the current time is slot n+20, the residual delay budget is 30 milliseconds.

The terminal device performs resource sensing from n-T₀ to n-T_{proc,0} (excluding n-T_{proc,0}), and the value of T₀ is 100 ms or 1100 ms. When the subcarrier interval is 15 kHz, 30 kHz, 60 kHz, or 120 kHz, T_{proc,0} is 1 slot, 1 slot, 2 slots, or 4 slots, respectively. Optionally, the terminal device performs resource sensing in slots within a resource sensing window, which belong to a resource pool used by the terminal device. Optionally, the terminal device will sense the first sidelink control information sent by other terminal devices in each slot (except its own transmission slot). After the resource selection or the resource reselection is triggered at slot n, the terminal device uses the results of resource sensing between n-T₀ and n-T_{proc,0}.

In Step 1, the terminal device determines all available resources belonging to the resource pool used by the terminal device in resource selection window 10 as a resource set A. Any resource in the set A is denoted by R(x,y), where x and y respectively indicate frequency domain location and the time domain location of the resource. An initial quantity of resources in the set A is denoted by Mₜₒₜₐₗ. The terminal device excludes resources from the resource set A according to unmonitored slot(s) in a resource sensing window 20 (see Step 1-1) and/or a resource sensing result in the resource sensing window 20 (see Step 1-2). The terminal device determines whether the resource R(x,y) or a series of periodic resources corresponding to the resource R(x,y) overlaps with a slot determined according to the unmonitored slot(s) in Step 1-1 or resource(s) determined according to the first sidelink control information monitored in Step 1-2; if there is an overlap, the resource R(x,y) is excluded from the resource set A.

In Step 1-1, if the terminal device sends data at slot tₘ in the sensing window 20 without sensing, the terminal device will determine the corresponding Q slots based on slot tₘ and each type of resource reservation period allowed in the resource pool used by the terminal device with the resource reservation period as an interval. If the Q slots overlap with the resource R(x,y) or the series of periodic resources corresponding to the resource R(x,y), the resource R(x,y) is excluded from the resource set A. Q=1 or Q=[Tscal/Prx] (representing rounding up), where Tscal is a value in milliseconds converted from T2, Prx is one type of the resource reservation periods allowed by the resource pool used by the terminal device. Optionally, the series of periodic resources corresponding to the resource R(x,y) are a series of periodic resources that are the same as frequency domain resource occupied by R(x,y) and mapped at certain time intervals, as shown in FIGS. 5A and 5B. The series of periodic resources corresponding to the resource R(x,y) includes the resource R(x,y).

For example, as illustrated in FIG. 5A, the terminal device does not perform sensing at slot tₘ, but performs resource exclusion sequentially according to each resource reservation period in the resource reservation period set M in the resource pool configuration used by the terminal device. For a certain resource reservation period 1, assuming that the value of Q is calculated to be 2, the corresponding Q slots are the next two slots mapped from the slot tₘ with the resource reservation period 1 as the interval, which are marked by horizontal shading in FIG. 5B. If the two slots marked by horizontal shading overlaps with the resource R(x,y) or the series of periodic resources corresponding to the resource R(x,y), the resource R(x,y) is excluded from the resource set A. For a certain resource reservation periods 2, assuming that the value of Q is calculated to be 1, the corresponding Q slot is one slot mapped from the slot tₘ with the resource reservation period 2 as an interval, which is marked by dot shading in FIG. 5A. If the slot marked by dot shading overlaps with the resource R(x,y) or the series of periodic resources corresponding to the resource R(x,y), the resource R(x,y) is excluded from the resource set A.

The terminal device will determine whether Q slot(s) corresponding to each reservation period overlap with the resource R(x,y) or the series of periodic resources corresponding to the resource R(x,y), and if there is an overlap, the resource R(x,y) is excluded from the resource set A.

Optionally, the terminal device may not perform the above Step 1-1 when the resource pool used by the terminal device deactivates the reservation between TBs.

Optionally, after Step 1-1 is executed, if the remaining resources in the resource set A are less than Mₜₒₜₐₗ×X, the resource set A is initialized to all the available resources belonging to the resource pool used by the terminal device in the resource selection window 10, and then Step1-2 is executed.

In Step 1-2, if the terminal device detects the first sidelink control information transmitted in the PSCCH at slot tₘ in the resource sensing window 20, sidelink reference signal received power (SL-RSRP) of the PSCCH or SL-RSRP of the PSSCH scheduled by the PSCCH (i.e., the SL-RSRP of the PSSCH transmitted in the same slot as the PSCCH) is measured.

If the measured SL-RSRP is greater than a SL-RSRP threshold, and the first sidelink control information monitored by the terminal device includes the “Resource reservation period” field, the terminal device determines the corresponding Q slots based on the slot tₘ and a resource reservation period carried in the monitored first sidelink control information with the resource reservation period as an interval. Assuming that the terminal device receives pieces of first sidelink control information having the same content in the Q slots, the terminal device determines whether the resources indicated by “Time resource assignment” fields and “Frequency resource assignment” fields in the first sidelink control information received in slot tₘ and the Q pieces of first sidelink control information that are assumed to be received overlap with the resource R(x,y) or the series of periodic resources corresponding to the resource R(x,y), and excludes the corresponding resource R(x,y) from the set A if there is an overlap. Q=1 or Q= [Tscal/Prx] (representing rounding up), where Tscal is a value in milliseconds converted from T₂, and Prx is a resource reservation period carried in the monitored first sidelink control information.

For example, as illustrated in FIG. 5B, if the terminal device detects the first sidelink control information in the PSCCH at slot tₘ, the first sidelink control information includes the “Resource reservation period” field, and the resource reservation period indicated by the field is Prx. It is assumed that the value of Q is calculated to be 1, and the terminal device receives the first sidelink control information having the same content in the next slot (i.e., the slot where resource 4 is located) starting at slot tₘ and spaced apart from slot tₘ with the interval Prx, the terminal device will determine whether resource 1, resource 2, resource 3, resource 4, resource 5 and resource 6 indicated by the “Time resource assignment” fields and “Frequency resource assignment” fields of the first sidelink control information received at slot tₘ and the first sidelink control information that is assumed to be received overlap with the resource R(x,y) or the series of periodic resources corresponding to the resource R(x,y). If there is an overlap and RSRP condition is met, the resource R(x,y) is excluded from the resource set A.

If the SL-RSRP measured by the terminal device is greater than the SL-RSRP threshold and the first sidelink control information monitored by the terminal device does not includes the “Resource reservation period” field, the terminal device only determines whether the resources indicated by the “Time resource assignment” field and “Frequency resource assignment” field of the first sidelink control information received in slot tₘ overlap with the resource R(x,y) or the series of resources corresponding to the resource R(x,y). If there is an overlap, the resource R(x,y) is excluded from the resource set A.

For example, as illustrated in FIG. 5B, if the terminal device detects the first sidelink control information in the PSCCH of slot tₘ, and the first sidelink control information does not include the “Resource reservation period” field, the terminal device determines whether resource 1, resource 2 and resource 3 indicated by the “Time resource assignment” field and “Frequency resource assignment” field of the first sidelink control information overlap with the resource R(x,y) or the series of periodic resources corresponding to the resource R(x,y). If there is an overlap and the RSRP condition is met, the resource R(x,y) is excluded from the resource set A.

If the remaining resources in the resource set A after the above resource exclusion are less than Mₜₒₜₐₗ×X, the SL-RSRP threshold is increased by 3 dB, and Step 1 is performed again. The physical layer reports the resource set A obtained after resource exclusion as a candidate resource set to the higher layer.

In Step 2, the higher layer randomly selects resources from the reported candidate resource set to send data. That is, the terminal device randomly selects resources from the candidate resource set to send data.

The following points should be noted.

1. The RSRP threshold is determined by the priority P1 carried in the PSCCH detected by the terminal device and the priority P2 of the data to be transmitted by the terminal device. The resource pool configuration used by the terminal device includes an SL-RSRP threshold table containing SL-RSRP thresholds corresponding to combinations of all the priorities. The resource pool configuration may be configured by the network or pre-configured.

For example, as illustrated in Table 1, it is assumed that values of the priority P1 and the priority P2 are each optionally selected from 0 to 7, the SL-RSRP thresholds corresponding to different combinations of priorities are represented by γᵢⱼ, where i in γᵢⱼ is a value of the priority P1 and j is a value of the priority P2.

TABLE 1
SL-RSRP threshold table

| | P2 | | | | | | | |
|---|---|---|---|---|---|---|---|---|
| P1 | 0 | 1 | 2 | 3 | 4 | 5 | 6 | 7 |
| 0 | γ₀₀ | γ₀₁ | γ₀₂ | γ₀₃ | γ₀₄ | γ₀₅ | γ₀₆ | γ₀₇ |
| 1 | γ₁₀ | γ₁₁ | γ₁₂ | γ₁₃ | γ₁₄ | γ₁₅ | γ₁₆ | γ₁₇ |
| 2 | γ₂₀ | γ₂₁ | γ₂₂ | γ₂₃ | γ₂₄ | γ₂₅ | γ₂₆ | γ₂₇ |
| 3 | γ₃₀ | γ₃₁ | γ₃₂ | γ₃₃ | γ₃₄ | γ₃₅ | γ₃₆ | γ₃₇ |
| 4 | γ₄₀ | γ₄₁ | γ₄₂ | γ₄₃ | γ₄₄ | γ₄₅ | γ₄₆ | γ₄₇ |
| 5 | γ₅₀ | γ₅₁ | γ₅₂ | γ₅₃ | γ₅₄ | γ₅₅ | γ₅₆ | γ₅₇ |
| 6 | γ₆₀ | γ₆₁ | γ₆₂ | γ₆₃ | γ₆₄ | γ₆₅ | γ₆₆ | γ₆₇ |
| 7 | γ₇₀ | γ₇₁ | γ₇₂ | γ₇₃ | γ₇₄ | γ₇₅ | γ₇₆ | γ₇₇ |

When the terminal device detects the PSCCH sent by other terminal device, and acquires the priority P1 carried in the first sidelink control information in the PSCCH and the priority P2 of the data to be transmitted, the terminal device determines the SL-RSRP threshold by looking up Table 1.

2. Whether measured PSCCH-RSRP or PSSCH-RSRP scheduled by the PSCCH is used by the terminal device for comparison with the SL-RSRP threshold depends on the resource pool configuration of the resource pool used by the terminal device. The resource pool configuration may be configured by network or pre-configured.

3. Regarding X, possible values for X may be {20, 35, 50}. The resource pool configuration used by the terminal device includes a correspondence between priorities and the above possible values. The terminal device determines the value of X according to the priority of the data to be transmitted and the correspondence. The resource pool configuration may be configured by the network or pre-configured.

4. Resource reservation periods are converted into logical slots.

As mentioned above, the terminal device transmits the first sidelink control information to indicate time-frequency resources, so as to reserve the resources that will be used next. When performing sensing, the terminal device for the resource selection will decode the first sidelink control information sent by other terminal devices to obtain resources reserved by other terminal devices, and excludes the corresponding resources when selecting resources, thereby avoiding resource collision. When performing resource exclusion, the terminal device for the resource selection will convert a physical time (e.g., 100 milliseconds) indicated by the “resource reservation period” field of the decoded first sidelink control information into a corresponding logical slot number, and then performs resource exclusion by utilizing the logical slot number:

$${P}_{rsvp}^{′} = ⌈ \frac{{T}_{max}^{′}}{10240 ms} \times {P}_{rsvp} ⌉ .$$

In the above formula, Pᵣₛᵥₚ is a resource reservation period. For example, Pᵣₛᵥₚ is the resource reservation period indicated by the “resource reservation period” field in the first sidelink control information monitored by the terminal device, a resource reservation period allowed in a resource pool, or a resource reservation period of the terminal device. P′ᵣₛᵥₚ is corresponding calculated logical slot number. T′ₘₐₓ is the quantity of slots belonging to the resource pool or transmitted resource pool of the terminal device within a system frame number (SFN) or 10240 milliseconds.

The above has described an SL communication mode in NR-V2X, i.e., the terminal device autonomously selects transmission resources through resource sensing and autonomously transmits data on sidelink. The SL communication mode may also be applied to various SL communications such as direct communication between handheld terminals, and direct communication between pedestrians and vehicles.

5. Physical layer structure in LTE V2X

A structure of a physical layer for SL communication in the LTE V2X system is illustrated in FIG. 6. The PSCCH is configured to carry the second sidelink control information, and the PSSCH is configured to carry data. The PSCCH and the PSSCH perform transmission in the same subframe. In LTE V2X, the PSCCH and the PSSCH may be continuous or non-continuous in the frequency domain.

The above second sidelink control information is carried in the PSCCH, and mainly includes fields related to resource sensing, which is beneficial for other terminal devices to perform resource exclusion and resource selection after decoding.

In addition, the resource reservation and the sensing-based resource selecting method for the LTE V2X system are similar to those for the NR V2X system, which will not be repeated in the present application. Some brief descriptions are provided in below. In the LTE V2X system, the first to third information fields in the second sidelink control information are used to indicate retransmission resources in the same TB. Optionally, fourth information field in the second sidelink control information is used to indicate transmission resources in another TB. The first information field refers to “Frequency resource location of the initial transmission and retransmission” (i.e., a frequency domain resource location indication of initial transmission and retransmission) in the second sidelink control information. The second information field refers to “Time gap between initial transmission and retransmission” (i.e., a time interval between initial transmission and retransmission) in the second sidelink control information. The third information field refers to “Retransmission index” (i.e., a retransmission index) in the second sidelink control information. The fourth information field refers to “Resource reservation” (i.e., resource reservation) in the second sidelink control information.

At present, one of the research projects for the R18 Sidelink standard is the coexistence of LTE Sidelink and NR Sidelink on overlapping frequency bands. For NR SL UE, there may be both the NR module and the LTE module. Since the terminal device can only transmit one TB in the same time unit on the same carrier, in a case where the transmission resources determined by the NR module and LTE module of the terminal device are in the same time unit, the terminal device can only transmit the data of one of the modules and give up the data transmission of the other module.

One solution to the above conflict is to consider the transmission resources of the LTE module in the resource exclusion of the NR module to avoid the above conflict.

Technical solutions of the present application will be described through several exemplary embodiments below.

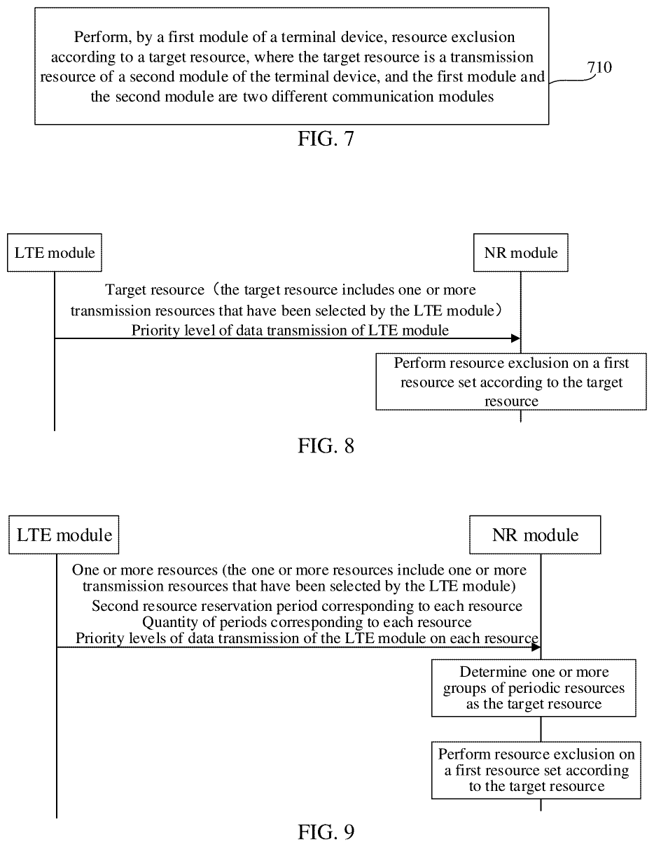

Reference is made to FIG. 7, which shows a flow chart of a resource exclusion method provided by an embodiment of the present application. The method may be applied to the network architecture shown in FIG. 1. For example, the method may be applied to a terminal device or performed by a terminal device. The terminal device includes a first module and a second module. The method may include the following steps:
step 710: performing, by the first module of the terminal device, resource exclusion according to target resource(s), where the target resource(s) are each a transmission resource of the second module of the terminal device, and the first module and the second module are two different communication modules.

In some embodiments, the first module and the second module are communication modules corresponding to two different communication systems. For example, the first module corresponds to a first communication system, the second module corresponds to a second communication system, and the first communication system and the second communication system are two different communication systems. Optionally, the first module is an NR module, and the second module is an LTE module or an evolved universal terrestrial radio access (E-UTRA) module. Certainly, the above is only exemplary and explanatory, and the present application does not limit the first module and the second module to correspond to other communication systems.

In some embodiments, the transmission resource of the second module is a selected resource of the second module; alternatively, the transmission resource of the second module is a scheduled resource of the second module. That is, the target resource is a selected or scheduled resource of the second module, and the resource may be a time-frequency resource. For example, the target resource is a time-frequency resource that has been selected (referred to as “selected” for short) of the second module, or the target resource is a time-frequency resource that has been scheduled (referred to as “scheduled” for short) of the second module. The resource that has been selected by the second module (or “selected resources of the second module”) refer to the resource autonomously selected from the resource pool by the second module of the terminal device, which corresponds to Mode B described above. The resource that has been scheduled of the second module (or “scheduled resource of the second module”) refer to the resource allocated by the access network device (e.g., a base station) to the second module of the terminal device, which corresponds to Mode A described above.

In some embodiments, the target resource includes one or more resources. For example, the target resource(s) may include only one resource, that is, there is one target resource. Alternatively, the target resource may include multiple resources, that is, there are multiple target resources. In the case where the target resource includes multiple resources, the time-frequency locations of the multiple resources are not limited in the present application. For example, among the multiple resources, there may exist resources with the same frequency-domain location but different time-domain locations, there may exist resources with different frequency-domain locations but the same time-domain location, or there may also exist resources with different frequency-domain locations and different time-domain locations.

In some embodiments, the target resource includes one or more groups of periodic resources. For example, the target resource may include only one group of periodic resources, or may include multiple groups of periodic resources. It should be noted that, for any group of periodic resources, the group of periodic resources may include multiple resources, and the multiple resources are arranged periodically in time domain. For example, a group of periodic resources may include multiple resources having the same frequency-domain location and different time-domain locations with a resource reservation period corresponding to the second module as an interval. However, the present application does not exclude that in some special cases, there is only one resource in a group of periodic resources, which may be understood that the quantity of periods is 0, or the period is 0, or no period is indicated. For example, the target resource includes two groups of periodic resources, one group of periodic resources includes multiple resources with the resource reservation period corresponding to the second module as an interval, and the other group of periodic resources includes only one resource.

In some embodiments, the target resource is indicated to the first module by the second module. For example, the second module sends first information to the first module, where the first information is used to indicate the target resource.

In some embodiments, the target resource includes one or more resources, and the second module indicates the one or more resources to the first module. For example, the second module sends first information to the first module, and the first information is used to indicate one or more resources included in the target resource. For example, the first information may include time-frequency location indication information of the one or more resources.

In some embodiments, the target resource includes one or more groups of periodic resources, the second module indicates one or more resources to the first module, and the first module determines one or more groups of periodic resources according to the one or more resources indicated by the second module. For example, the second module sends first information to the first module, where the first information is used to indicate one or more resources; accordingly, the first module determines one or more resources based on the received first information, and then determines one or more groups of periodic resources based on the one or more resources. Exemplarily, the first information may include time-frequency location indication information of the one or more resources mentioned above. Optionally, for any one of the one or more resources indicated by the second module, the first module may determine a group of periodic resources corresponding to the one resource. Similarly, a group of periodic resources here usually includes multiple resources, but it is not excluded that there may exist only one resource in some cases.

Optionally, in the case where the target resource includes one or more groups of periodic resources, in addition to indicating one or more resources to the first module, the second module may further indicate a resource reservation period corresponding to the second module to the first module, and/or indicate a quantity of periods number of at least one resource to the first module, where the quantity of periods of the resource is used to determine a group of periodic resources corresponding to the resource.

Optionally, the resource reservation period corresponding to the second module may be referred to as a second resource reservation period, the second resource reservation period refers to a resource reservation period in a second resource reservation period set, and the second resource reservation period set includes one or more types of resource reservation periods allowed in a second communication system (i.e., a communication system corresponding to the second module); in other words, the second resource reservation period refers to the resource reservation period allowed in the second communication system (i.e., the communication system corresponding to the second module). Optionally, the first module determines one or more groups of periodic resources as a target resource according to the one or more resources indicated by the second module and the resource reservation period corresponding to the second module. For example, for any resource (denoted as a resource P(x, y), where x and y respectively indicate the frequency-domain location and time-domain location of the resource) of the one or more resources indicated by the second module, the first module may determine a group of periodic resources corresponding to the resource P(x, y); in a case where the group of periodic resources corresponding to the resource P(x, y) includes multiple resources, the group of periodic resources may include periodic resources including the resource P(x, y) and having the same frequency-domain location as the resource P(x, y) and different time-domain locations with the resource reservation period corresponding to the second module as an interval; in a case where the group of periodic resources corresponding to the resource P(x, y) has only one resource, the group of periodic resources may only include the resource P(x, y).

Optionally, the second module may indicate the quantity of periods of each of the one or more resources indicated by the second module to the first module. For example, for the resource P(x, y) indicated by the second module, the second resource reservation period corresponding to the resource P(x, y) is denoted as Ptx, and the quantity of periods corresponding to the resource P(x, y) is denoted as Cresel, then a group of periodic resources corresponding to the resource P(x, y) is P(x, y+j×Ptxlg), where j=0, 1,2, . . . , Cresel-1, and Ptxlg is a quantity of logical time slots converted from the second resource reservation period Ptx. In the case where the quantity of resources indicated by the second module is multiple, the multiple resources may correspond to the same quantity of periods, or at least two resources correspond to different quantities of periods. In addition, in a case where the quantity of periods corresponding to a certain resource is a first set value (e.g., 0), or in a case where the quantity of periods corresponding to a certain resource is not indicated, or in a case where the second resource reservation period corresponding to a certain resource is a second set value (e.g., 0), or in a case where the second resource reservation period corresponding to a certain resource is not indicated, it may be understood as there is only one resource in a group of periodic resources corresponding to the resource, that is, only the resource itself is included.

Optionally, for any resource indicated by the second module, if the second module indicates only the second resource reservation period corresponding to the resource but does not indicate the quantity of periods corresponding to the resource, the quantity of periods corresponding to the resource may depend on the implementation of the first module.

It should be noted that for each resource of the one or more resources indicated by the second module, the first module may determine a group of periodic resources; in the case where the quantity of resources indicated by the second module is multiple, for any two of the resources, when determining the corresponding periodic resources, the second resource reservation periods used may be the same or different, and the quantity of periods used may be the same or different, which is not limited in the present application. For example, for the resource P(x, y) and resource Q (x, y) indicated by the second module, the second resource reservation period corresponding to the resource P(x, y) is denoted as Ptx₁, and the quantity of periods corresponding to the resource P(x, y) is denoted as Cresel₁, the second resource reservation period corresponding to the resource Q (x, y) is denoted as Ptx₂, and the quantity of periods corresponding to the resource Q (x, y) is denoted as Cresel₂, where Ptx₁ and Ptx₂ may be the same or different, and Cresel₁ and Cresel₂ may be the same or different.

In some embodiments, the target resource includes one or more groups of periodic resources, and the second module indicates one or more groups of periodic resources to the first module. For example, the second module sends first information to the first module, and the first information is used to indicate one or more groups of periodic resources included in a target resource; for example, the first information may include time-frequency location indication information of each resource of the one or more groups of periodic resources. After receiving the first information, the first module may directly determine one or more groups of periodic resources included in the target resource according to the first information, without having to calculate one or more groups of periodic resources according to information such as the resource reservation period and the quantity of periods. This method may simplify the processing flow of the first module, but the amount of information exchanged between the first module and the second module may be increased compared with the method described above.

In some embodiments, the first module and the second module perform transmission on the same carrier. Since the terminal device is able to transmit only one TB in the same time unit on the same carrier, in a case where the first module and the second module of the terminal device perform transmission on the same carrier, the problem of transmission conflict needs to be considered, and the problem of transmission conflict may be effectively solved by adopting the technical solutions of the present application.

In some embodiments, performing, by the first module of the terminal device, resource exclusion according to the target resource includes: performing, by the first module, resource exclusion on the first resource set according to the target resource.

In some embodiments, the first resource set includes all available resources in a resource selection window. In other words, the first resource set is a set consisting of all available resources in the resource selection window.

In some embodiments, the first resource set includes available resources in part of the time units in the resource selection window. In other words, the first resource set is a set consisting of available resources in part of the time units in the resource selection window. For example, the first resource set is a set consisting of all available resources in part of the time units in the resource selection window.

In some embodiments, the first resource set includes remaining resources obtained after at least one resource exclusion step is performed on all available resources in the resource selection window. In other words, the first resource set is a set consisting of remaining resources obtained after at least one resource exclusion step is performed on all the available resources in the resource selection window.

In some embodiments, the first resource set includes remaining resources obtained after at least one resource exclusion step is performed on available resources in part of the time units in the resource selection window. In other words, the first resource set is a set consisting of remaining resources obtained after at least one resource exclusion step is performed on available resources in part of the time units in the resource selection window. For example, the first resource set is a set consisting of remaining resources obtained after at least one resource exclusion step is performed on all available resources in part of the time units in the resource selection window.

Optionally, the above at least one resource exclusion step may be a resource exclusion step performed by the terminal device according to monitored sidelink control information and/or according to unmonitored time unit(s). Optionally, the above at least one resource exclusion step includes at least one of the following:
a first exclusion step used for resource exclusion based on monitored first sidelink control information;
a second exclusion step, used for resource exclusion based on monitored second sidelink control information; or
a third exclusion step, used for resource exclusion based on unmonitored time unit(s);
where the first sidelink control information and the second sidelink control information are two different pieces of sidelink control information.

Optionally, the first sidelink control information is sidelink control information monitored by the first module, and the second sidelink control information is sidelink control information monitored by the second module.

Exemplarily, the first resource set is a set consisting of remaining resources obtained after the first exclusion step and the second exclusion step are performed on a set consisting of all available resources in the resource selection window.

Exemplarily, the first resource set is a set consisting of remaining resources obtained after the first exclusion step, the second exclusion step and the third exclusion step are performed on a set consisting of all available resources in the resource selection window.

Exemplarily, the first resource set is a set consisting of remaining resources obtained after the first exclusion step, the second exclusion step, or the third exclusion step is performed on a set consisting of all available resources in the resource selection window.

In some embodiments, the first module performing resource exclusion on the first resource set based on the target resource, includes: for a first resource in a first resource set, if the first resource meets an exclusion condition, the first module excluding the first resource from the first resource set, where the exclusion condition includes the first resource or a periodic resource corresponding to the first resource overlapping with the target resource. Optionally, the periodic resource corresponding to the first resource includes a periodic resource including the first resource and having the same frequency-domain location as the first resource and different time-domain locations with a resource reservation period corresponding to the first module as an interval. Optionally, the resource reservation period corresponding to the first module may be referred to as a first resource reservation period, the first resource reservation period refers to a resource reservation period in a first resource reservation period set, and the first resource reservation period set includes one or more types of resource reservation periods allowed in the first communication system (i.e., the communication system corresponding to the first module); in other words, the first resource reservation period refers to a resource reservation period allowed in the first communication system (i.e., the communication system corresponding to the first module). Optionally, the term “overlapping” in the present application refers to overlapping in the time-domain, i.e., two resources overlapping, which may be understood as the two resources overlapping in the time-domain, the overlapping may be partially overlapping or a completely overlapping, which is not limited in the present application.

Optionally, the first resource may be any one resource in the first resource set. For example, for each resource in the first resource set, it is detected whether the resource meets the exclusion condition, if the resource meets the exclusion condition, the resource will be excluded from the first resource set. For example, for the resource R(x, y) in the first resource set, x and y respectively indicating the frequency-domain location and time-domain location of the resource, it is detected whether the resource R(x, y) meets the exclusion condition, if the resource R(x, y) meets the exclusion condition, the resource R(x, y) will be excluded from the first resource set. The exclusion condition includes: the resource R(x, y) or a periodic resource corresponding to the resource R(x, y) overlapping with the target resource.

Optionally, the first resource or the periodic resource corresponding to the first resource overlapping with the target resource(s) includes: the first resource or the periodic resource corresponding to the first resource overlapping with any one of the target resource(s), or the first resource or the periodic resources corresponding to the first resource overlapping with any one group of periodic resources in the target resource.

Optionally, in a case where the first resource or the periodic resource corresponding to the first resource overlaps with any one group of periodic resources in the target resource, the exclusion condition further includes: the quantity of resources overlapping is greater than or equal to a quantity threshold. Optionally, the quantity threshold is denoted as a threshold T, and the threshold T may be configured by network, or pre-configured, or a value specified by the standard, or may depend on the implementation of the terminal device.

Optionally, the exclusion condition further includes: the priority level of data transmission of the second module is higher than the priority level of data transmission of the first module and/or higher than a priority level threshold. Optionally, the priority level of data transmission of the second module is the priority level of data transmitted by the second module on the target resource. Optionally, the second module indicates the priority level of data transmission of the second module to the first module. Optionally, the above priority level threshold is denoted as a threshold U, and the threshold U may be configured by network, or pre-configured, or a value specified by the standard, or may depend on the implementation of the terminal device.

Optionally, the priority level of data transmission of the first module/second module mentioned above may be the priority level of the data to be transmitted (or data to be sent) of the first module/second module, or the priority level of the data being transmitted (or data being sent) by the first module/second module. In addition, the priority level is represented by a priority level value, the greater the priority level value, the higher the priority level; in this case, the above-mentioned the priority level of data transmission of the second module being higher than the priority level of data transmission of the first module and/or higher than the priority level threshold means that the priority level value of data transmission of the second module is larger than the priority level value of data transmission of the first module and/or greater than the priority level threshold; and the smaller the priority level value, the higher the priority level; in this case, the above-mentioned the priority level of data transmission of the second module being higher than the priority level of data transmission of the first module and/or higher than the priority level threshold means that the priority level value of data transmission of the second module is smaller than the priority level value of data transmission of the first module and/or smaller than the priority level threshold. All other description regarding priority level in the present application may be construed accordingly.

In addition, the “time unit” mentioned in the embodiments of the present application may be a time slot, a subframe, or other time units, which is not limited in the present application. For the “time unit” mentioned elsewhere in the description, the explanation may be referred to and will not be repeated.

According to the technical solutions provided by the embodiments of the present application, the first module of the terminal device performs resource exclusion according to the target resource(s), and the target resource is the transmission resource of the second module of the terminal device, and the first module and the second module are two different communication modules. In this way, when the first module performs resource exclusion, the resource(s) that conflict with the selected or scheduled resource(s) of the second module may be excluded, thereby avoiding conflicts in time domain between transmission resources determined by the first module and the second module, and improving communication reliability.

A method for a terminal device to determine a first resource set will be described below.

In some embodiments, the method for the terminal device to determine the first resource set is as follows:
determining a resource selection window and resource sensing window(s);
determining available resources in the resource selection window as an initialized resource set; and
performing at least one resource exclusion step to exclude resource(s) in the resource set to obtain a first resource set, where the at least one resource exclusion step includes at least one of the first exclusion step, the second exclusion step or the third exclusion step described in the above embodiments.

In the embodiments of the present application, a time duration corresponding to the resource selection window is not limited. Exemplarily, the resource selection window may employ the design in the NR V2X system. For example, the resource selection window starts at n+T₁ and ends at n+T₂, where the time unit n (e.g., slot n) is a time unit in which resource selection or reselection is triggered or the high layer triggers the physical layer to report a candidate resource set, the descriptions for T₁ and T₂ may be referred to the above. Optionally, in a case where the first sidelink control information is the sidelink control information in the NR system, the resource selection window may employ the design in the NR V2X system described above.

Optionally, the quantity of resource sensing windows may be two or one.

Optionally, in the case where the quantity of resource sensing windows is two, the resource sensing windows include a first resource sensing window and a second resource sensing window. The terminal device detects the first sidelink control information in the first resource sensing window, and detects the second sidelink control information in the second resource sensing window. The first resource sensing window and the second resource sensing window are two different resource sensing windows. For example, a time duration corresponding to the first resource sensing window is different from a time duration corresponding to the second resource sensing window. Exemplarily, the first resource sensing window starts at n-T₀₀ and ends at n-T_{proc,0} (excluding n-T_{proc,0}), where Too is 1100 milliseconds or 100 milliseconds, and descriptions relating to T_{proc,0} may be referred to the foregoing descriptions. The second resource sensing window starts at n-T₁₀ and ends at n (excluding n), where T₁₀ is 1000 milliseconds, and the time unit n (e.g., slot n) is a time unit for triggering resource selection or reselection or a time unit for the high layer to trigger the physical layer to report a candidate resource set. Optionally, in the case where the first sidelink control information is sidelink control information in the NR system, the first resource sensing window employs the design in the NR V2X system, for example, starting at n-T₀₀ and ending at n-T_{proc,0} (excluding n-T_{proc,0}). Optionally, in the case where the second sidelink control information is sidelink control information in the LTE system, the second resource sensing window employs the design in the LTE V2X system, i.e., starting at n-T₁₀ and ending at n (excluding n).

Optionally, in the case where the quantity of the resource sensing windows is one, as an example, the resource sensing window includes a first resource sensing window, and the terminal device detects the first sidelink control information and the second sidelink control information in the first resource sensing window. As another example, the resource sensing window includes a second resource sensing window, and the terminal device detects the first sidelink control information and the second sidelink control information in the second resource sensing window. The first resource sensing window and the second resource sensing window are two different resource sensing windows. For descriptions regarding the first resource sensing window and the second resource sensing window, reference may be made to the descriptions in the previous paragraph, which will be not repeated here.

Optionally, the terminal device detects the first sidelink control information and the second sidelink control information in the resource sensing window. Exemplarily, the resource sensing window starts at n-T₀₀ and ends at n-T_{proc,0} (excluding n-T_{proc,0}), where T₀₀ is 1100 milliseconds or 100 milliseconds, and descriptions for T_{proc,0} is referred to the foregoing descriptions.

Optionally, the first exclusion step is performed before the second exclusion step, or the first exclusion step is performed after the second exclusion step.

Optionally, in the case where the quantity of the resource sensing windows is one, the third exclusion step is used for resource exclusion based on unmonitored time unit(s) in the one resource sensing window. For example, in the case where the resource sensing window is the first resource sensing window, the third exclusion step is used to perform resource exclusion according to unmonitored time unit(s) in the first resource sensing window. As another example, in the case where the resource sensing window is the second resource sensing window, the third exclusion step is used to perform resource exclusion according to unmonitored time unit(s) in the second resource sensing window.

Optionally, in the case where the quantity of the resource sensing windows is two, for example, the resource sensing window includes the first resource sensing window and the second resource sensing window described above, the third exclusion step is used to perform resource exclusion according to the unmonitored time unit(s) in the first resource sensing window and the unmonitored time unit(s) in the second resource sensing window, i.e., perform resource exclusion according to unmonitored time unit(s) in an union of the first resource sensing window and the second resource sensing window; alternatively, the third exclusion step is used to perform resource exclusion according to the unmonitored time unit(s) in the first resource sensing window only; alternatively, the third exclusion step is used to perform resource exclusion according to the unmonitored time unit(s) in the second resource sensing window only.

In an exemplary embodiment, after determining the resource selection window and the resource sensing window(s), the terminal device performs the resource exclusion process described in the following steps (1) to (5):
(1) initializing, by the terminal device, all available resources in the resource selection window as a resource set A, any resource in the resource set A being denoted by R(x, y), where x and y represent a frequency-domain location and a time-domain location of the resource, respectively, and the quantity of initial resources in the resource set A being denoted by Mₜₒₜₐₗ;
(2) performing, by the terminal device, resource exclusion according to the unmonitored time unit(s) in the resource sensing window(s), i.e., performing, by the terminal device, the third exclusion step;
(3) performing, by the terminal device, resource exclusion according to the first sidelink control information monitored in the resource sensing window(s), i.e., performing, by the terminal device, the first exclusion step;
(4) performing, by the terminal device, resource exclusion according to the second sidelink control information monitored in the resource sensing window(s), i.e., performing, by the terminal device, the second exclusion step;
(5) if the quantity of remaining resources in resource set A being less than Mₜₒₜₐₗ×X, increasing the RSRP threshold by 3 dB, and repeating the step (1), where X is configured by network or pre-configured.

Optionally, the first resource set mentioned above may be the resource set A obtained after step (2) is performed, or the resource set A obtained after step (3) is performed, or the resource set A obtained after step (4) is performed. In this case, the terminal device may perform resource exclusion on the first resource set according to the target resource during performing the above steps (1) to (5).

Optionally, the first resource set mentioned above may be the resource set A obtained after the all above resource exclusion processes are performed, i.e., the resource set A obtained after step (5) is performed. In this case, after performing the above steps (1) to (5), the terminal device may perform resource exclusion on the first resource set according to the target resource(s).

Optionally, the terminal device may not perform step (2). Optionally, in a case where the quantity of remaining resources in the resource set A is less than Mₜₒₜₐₗ×X after the terminal device performs step (2), the resource set A will be initialized to the resource set A obtained before step (2) is performed, and then subsequent steps are performed.

Optionally, the order in which the terminal device performs steps (2), (3), and (4) may be adjustable. For example, step (2) is performed first, step (3) is performed next, and step (4) is performed finally. Alternatively, step (2) is performed first, step (4) is performed next, and then step (3) is performed.

Optionally, the third exclusion step includes: according to resource reservation periods in a third resource reservation period set and/or fourth resource reservation period set and the unmonitored time unit(s), determining Q3 time units corresponding to the unmonitored time unit(s), where Q3 is a positive integer; in response that Q3 time units overlap with an available resource in the resource set or a periodic resource corresponding to the available resource, excluding the available resource from the resource set. The available resource in the resource set may be any one resource included in the resource set.

For example, the above available resource is the resource R(x, y), where x and y respectively indicate the frequency-domain location and time-domain location of the resource; for the step (2), the terminal device determines, according to each type of resource reservation period in the third resource reservation period set and/or fourth resource reservation period set and the unmonitored time unit, the corresponding Q3 time units, and excludes the resource R(x, y) from the resource set A in response that the Q3 time units overlap with the resource R(x, y) or a series of periodic resources corresponding to the resource R(x, y).

Optionally, the third resource reservation period set includes one or more types of resource reservation periods allowed in the first communication system; alternatively, the third resource reservation period set includes one or more types of resource reservation periods allowed in the first communication system and one or more types of resource reservation periods allowed in the second communication system. The first communication system is a communication system corresponding to the first sidelink control information, and the second communication system is a communication system corresponding to the second sidelink control information.

Optionally, the fourth resource reservation period set includes one or more types of resource reservation periods allowed in a second communication system, and the second communication system is a communication system corresponding to the second sidelink control information.

In a possible scenario, the above third exclusion step includes: determining, according to the resource reservation period in the third resource reservation period set and the unmonitored time unit(s), Q3 time units corresponding to the unmonitored time unit(s). The configuration of the resource pool includes a resource reservation period set, such as a third resource reservation period set, and the third resource reservation period set includes one or more types of resource reservation periods allowed in the first communication system.

In another possible scenario, the third exclusion step includes: determining, according to the resource reservation period in the third resource reservation period set and the unmonitored time unit(s), Q3 time units corresponding to the unmonitored time unit(s). The configuration of the resource pool includes a resource reservation period set, such as a third resource reservation period set; the third resource reservation period set includes one or more types of resource reservation periods allowed in the first communication system and one or more types of resource reservation periods allowed in the second communication system.

In yet another possible scenario, the third exclusion step includes: determining, according to the resource reservation periods in the third resource reservation period set and fourth resource reservation period set and the unmonitored time unit(s), Q3 time units corresponding to the unmonitored time unit(s). The configuration of the resource pool includes two resource reservation period sets, such as a third resource reservation period set and a fourth resource reservation period set; the third resource reservation period set includes one or more types of resource reservation periods allowed in the first communication system, and the fourth resource reservation period set includes one or more types of resource reservation periods allowed in the second communication system.

Exemplarily, the first communication system is an NR system, and the second communication system is an LTE system or an E-UTRA system.

Optionally, the first exclusion step includes: according to the first time unit of the monitored first sidelink control information and the resource reservation period indicated by the first sidelink control information, determining Q1 time units corresponding to the first time unit; assuming that pieces of the first sidelink control information with the same content are received in the Q1 time units, where Q1 is a positive integer; in response that the resources indicated by the first sidelink control information monitored or assumed to be received overlap with the available resource in the resource set or the periodic resource corresponding to the available resource, and a first RSRP threshold condition is met, excluding the available resource from the resource set. Alternatively, the first exclusion step includes: determining whether the resource(s) indicated by the monitored first sidelink control information overlap with the available resource in the resource set or the periodic resource corresponding to the available resource; and in response that these pieces of resources overlap and the first RSRP threshold condition is met, excluding the available resource from the resource set.

For example, the above available resource is the resource R(x, y); for the above step (3), the terminal device determines the corresponding Q1 time units according to the time unit where the first sidelink control information is monitored and the resource reservation period indicated by the first sidelink control information, assumes that pieces of the first sidelink control information with the same content are received in the Q1 time units, and excludes the resource R(x, y) from the resource set A in response that the resource(s) indicated by the “Time resource assignment” and “Frequency resource assignment” in the first sidelink control information monitored or assumed to be received overlap with the resource R(x, y) or a series of periodic resources corresponding to the resource R(x, y), and the first RSRP threshold condition is met. Alternatively, the terminal device determines whether the resource(s) indicated by the “Time resource assignment” and “Frequency resource assignment” in the monitored first sidelink control information overlap with the resource R(x, y) or a series of periodic resources corresponding to the resource R(x, y), and excludes the resource R(x, y) from the resource set A in response that these pieces of information overlap and the first RSRP threshold condition is met. The above-mentioned the first RSRP threshold condition being met means that the RSRP of the PSCCH where the monitored first sidelink control information is located or the RSRP of the PSSCH scheduled by the PSCCH is greater than the first RSRP threshold. The first RSRP threshold may be determined according to the priority level indicated by the first sidelink control information and the priority level of data transmission.

Optionally, the second exclusion step includes: determining, according to a second time unit in which the second sidelink control information is monitored and a resource reservation period indicated by the second sidelink control information, Q2 time units corresponding to the second time unit; assuming that pieces of second sidelink control information with the same content are received in the Q2 time units, where Q2 is a positive integer; and excluding, in response that resources indicated by the second sidelink control information monitored or assumed received overlap with a target resource in the resource set or a periodic resource corresponding to the target resource and a second RSRP threshold condition is met, the target resource from the resource set.

For example, the above available resource is the resource R(x, y); for the above step (4), the terminal device determines the corresponding Q2 time units according to the time unit where the second sidelink control information is monitored and the resource reservation period indicated by the second sidelink control information, assumes that pieces of second sidelink control information with the same content are received in the Q2 time units, and excludes the resource R(x,y) from the resource set A in response that the resources indicated by a first to third information fields in the second sidelink control information monitored or assumed to be received overlap with the resource R(x,y) or a series of periodic resources corresponding to the resource R(x,y) and a second RSRP threshold condition is met. The above-mentioned the second RSRP threshold condition being met means that the RSRP of the PSSCH scheduled by the monitored second sidelink control information is greater than a second RSRP threshold. The second RSRP threshold may be determined according to the priority level indicated by the second sidelink control information and the priority level of data transmission. In addition, the above-mentioned first information field refers to the frequency resource location of the initial transmission and retransmission (i.e., a frequency-domain resource location indication of initial transmission and retransmission) in the second sidelink control information, the second information field refers to the a time gap between initial transmission and retransmission (i.e., a time interval between initial transmission and retransmission) in the second sidelink control information, and the third information field refers to the retransmission index (i.e., a retransmission index) in the second sidelink control information.

Optionally, the same RSRP threshold table is configured for the first exclusion step and the second exclusion step. For example, the same RSRP threshold table may be configured for step (3) and step (4) through network configuration or pre-configuration, which contains RSRP thresholds corresponding to all priority level combinations. The first RSRP threshold is determined by way of table look-up according to the priority level indicated by the first sidelink control information and the priority level of data transmission, and the second RSRP threshold is determined by way of table look-up according to the priority level indicated by the second sidelink control information and the priority level of data transmission. Accordingly, increasing the RSRP threshold by 3 dB means that all the RSRP thresholds corresponding to various priority level combinations are each increased by 3 dB.

Optionally, different RSRP threshold tables are configured for the first exclusion step and the second exclusion step. For example, different RSRP threshold tables may be configured for step (3) and step (4) by way of configuring by network or pre-configuring, which are denoted as a first RSRP threshold table and a second RSRP threshold table, respectively. The first RSRP threshold is determined by looking up the first RSRP threshold table according to the priority level indicated by the first sidelink control information and the priority level of data transmission. Similarly, the second RSRP threshold is determined by looking up the second RSRP threshold table according to the priority level indicated by the second sidelink control information and the priority level of data transmission. Accordingly, increasing the RSRP threshold by 3 dB means that all the RSRP thresholds corresponding to various priority level combinations in the first RSRP threshold table and the second RSRP threshold table are each increased by 3 dB.

Optionally, the above-mentioned priority level of data transmission may be the priority level of the data to be transmitted (or the data to be sent) of the terminal device, or may be the priority level of the data being transmitted (or the data being sent) of the terminal device.

In addition, the process of the terminal device determining the first resource set may be performed by the first module, but it is not excluded that it can be performed by the second module, or performed by the interaction and cooperation of the first module and the second module, which is not limited in the present application.

In some embodiments, for any resource R(x, y) in the first resource set, if the resource R(x, y) or a series of periodic resources (including the resource R(x, y)) corresponding to the resource R(x, y) overlaps with any one of the target resources in time domain, the resource R(x, y) will be excluded from the first resource set.

In some embodiments, for any resource R(x, y) in the first resource set, if the resource R(x, y) or a series of periodic resources (including the resource R(x, y)) corresponding to the resource R(x, y) overlaps with any one of the target resources in time domain, and the priority level of data transmission of the second module is higher than the priority level of data transmission of the first module and/or higher than the priority level threshold U, then the resource R(x, y) will be excluded from the first resource set. The priority level threshold U is configured by network or preconfigured or implemented by the terminal device or is a value specified by the standard. Exemplarily, the priority level of data transmission of the second module is the priority level of data transmission of the second module on the target resource or the priority level of data transmitted by the second module on the target resource. Exemplarily, the second module indicates the priority level corresponding to the target resource to the first module. In addition, the target resource may include one or more resources. In a case where the target resource includes multiple resources, the priority levels corresponding to any two resources may be the same or different.

The periodic resource corresponding to the resource R(x, y) is a periodic resource including the resource R(x, y) and having the same frequency-domain location as the resource R(x, y) and different time-domain locations with the first resource reservation period as an interval. The first resource reservation period is a resource reservation period corresponding to the first module.

For example, as shown in FIG. 8, the LTE module indicates a target resource to the NR module, and the target resource includes one or more transmission resources that have been selected by the LTE module. The NR module determines a resource selection window, and the first resource set is a set consisting of remaining resources obtained after the first, second and third exclusion steps are performed on the set consisting of all available resources in the resource selection window. For any resource R(x, y) in the first resource set, if the resource R(x, y) or a series of periodic resources (including the resource R(x, y)) corresponding to the resource R(x, y) overlaps with any one of the target resource in time domain, the resource R(x, y) will be excluded from the first resource set.

For another example, as shown in FIG. 8, the LTE module indicates a target resource and a priority level of the LTE module transmitting on the target resource to the NR module, the target resource includes one or more transmission resources that have been selected by the LTE module. The NR module determines a resource selection window, and the first resource set is a set consisting of remaining resources obtained after the first, second and third exclusion steps are performed on the set consisting of all available resources in the resource selection window. For any resource R(x, y) in the first resource set, if the resource R(x, y) or a series of periodic resources (including the resource R(x, y)) corresponding to the resource R(x, y) overlaps with any one of the target resources in time domain, and the priority level of the LTE module transmitting on the target resource is higher than the priority level of data transmission of the NR module, the resource R(x, y) will be excluded from the first resource set.

In some embodiments, for any resource R(x, y) in the first resource set, if the resource R(x, y) or a series of periodic resources (including the resource R(x, y)) corresponding to the resource R(x, y) overlaps with any one group of periodic resources in the target resource in time domain, or the quantity of resources overlapping in time domain is greater than or equal to a quantity threshold T, then the resource R(x, y) will be excluded from the first resource set. Optionally, a group of periodic resources corresponding to the resource P(x, y) in the target resource is a group of periodic resources including the resource P(x, y) and having the same frequency-domain location as the resource P(x, y) with a second resource reservation period as an interval. The second resource reservation period is a resource reservation period corresponding to the second module. Exemplarily, the second module indicates one or more resources to the first module, and the second module indicates the second resource reservation period corresponding to each of the above one or more resources to the first module. Exemplarily, the second module may also indicate the quantities of period corresponding to each of the above one or more resources to the first module, and the quantity of periods of the resource is used to determine a group of periodic resources corresponding to the resource. The quantity threshold T is configured by network or pre-configured or is a value specified by the standard or depending on the implementation of the terminal device.

In some embodiments, for any resource R(x, y) in the first resource set, if the resource R(x, y) or a series of periodic resources (including the resource R(x, y)) corresponding to the resource R(x, y) overlaps with any one group of periodic resources in the target resource in time domain, or if the quantity of resources overlapping in time domain is greater than or equal to the quantity threshold T and the priority level of data transmission of the second module is higher than the priority level of data transmission of the first module and/or higher than the priority level threshold U, then the resource R(x, y) will be excluded from the first resource set. The priority level threshold U is configured by network or pre-configured or implemented by the terminal device or is a value specified by the standard. Exemplarily, the priority level of data transmission of the second module is the priority level of data transmission of the second module on the target resource or the priority level of data transmitted by the second module on the target resource. Exemplarily, the second module indicates the priority level corresponding to the target resource to the first module. Any group of periodic resources in the target resource and the second resource reservation period may be referred to the above description. In addition, the target resource may include one or more groups of periodic resources, in a case where the target resource includes multiple groups of periodic resources, the priority levels corresponding to any two groups of periodic resources may be the same or different. In addition, the second module indicates the priority level corresponding to the target resource to the first module, and indicates the priority level corresponding to each of the one or more groups of periodic resources included in the target resource to the first module. Optionally, the method of indicating priority level may be that each group of periodic resources included in the target resource corresponds to a priority level, or that each resource indicated by the second module corresponds to a priority level, and the priority level represents the priority level corresponding to the periodic resource determined according to the resource.

For example, as shown in FIG. 9, the LTE module indicates one or more resources, the second resource reservation period and the quantity of periods corresponding to each resource to the NR module; the one or more resources described above include one or more transmission resources that have been selected by the LTE module. The NR module determines a resource selection window, and the first resource set is a set consisting of resources remained after the first, the second and the third exclusion steps are performed on the set consisting of all available resources in the resource selection window. The NR module determines one or more groups of periodic resources as the target resource according to the one or more resources, the second resource reservation period and the quantity of periods corresponding to each resource indicated by the LTE module. For any resource R(x, y) in the first resource set, if the resource R(x, y) or a series of periodic resources (including the resource R(x, y)) corresponding to the resource R(x, y) overlaps with any group of periodic resources in the target resource in time domain, the resource R(x, y) will be excluded from the first resource set. For any resource indicated by the LTE module, a group of periodic resources corresponding to the resource is periodic resources having the same frequency-domain location as the resource with a second resource reservation period corresponding to the resource as an interval; the quantity of periods is determined according to the indication of the second module.

For another example, as shown in FIG. 9, the LTE module indicates one or more resources, the second resource reservation period and the quantity of periods corresponding to each resource, and the priority level of data transmission of the LTE module on each resource to the NR module; the above-mentioned one or more resources include one or more transmission resources that have been selected by the LTE module. The NR module determines a resource selection window, and the first resource set is a set consisting of remaining resources obtained after the first, second and third exclusion steps are performed on the set consisting of all the available resources in the resource selection window. The NR module determines one or more groups of periodic resources as the target resource according to the one or more resources, the second resource reservation period and the quantity of periods corresponding to each resource indicated by the LTE module. For any resource R(x, y) in the first resource set, if the resource R(x, y) or a series of periodic resources (including the resource R(x, y)) corresponding to the resource R(x, y) overlaps with any one group of periodic resources in the target resource in time domain, and the priority level of transmission of the LTE module on the resource corresponding to the group of periodic resources is higher than the priority level of data transmission of the NR module, then the resource R(x, y) will be excluded from the first resource set. For any resource indicated by the LTE module, a group of periodic resources corresponding to the resource are periodic resources, with a second resource reservation period corresponding to the resource as an interval, having the same frequency-domain location as the resource; the quantity of periods is determined according to the indication of the second module.

In some embodiments, for any resource R(x, y) in the first resource set, if the resource R(x, y) or a series of periodic resources (including the resource R(x, y)) corresponding to the resource R(x, y) overlaps with any group of periodic resources in the target resource in time domain or the quantity of resources overlapping in time domain is greater than or equal to a quantity threshold T, then the resource R(x, y) will be excluded from the first resource set. The quantity threshold T is configured by network or preconfigured, or is a value specified by the standard, or depends on the implementation of the terminal device. Any group of periodic resources in the target resource consists of periodic resources having the same frequency-domain location and different time-domain locations with a second resource reservation period as an interval. The second resource reservation period is a resource reservation period corresponding to the second module. Exemplarily, the second module indicates one or more groups of periodic resources included in the target resource to the first module.

In some embodiments, for any resource R(x, y) in the first resource set, if the resource R(x, y) or a series of periodic resources (including the resource R(x, y)) corresponding to the resource R(x, y) overlaps with any group of periodic resources in the target resource in time domain, or if the quantity of resources overlapping in time domain is greater than or equal to a quantity threshold T and the priority level of data transmission of the second module is higher than the priority level of data transmission of the first module and/or higher than a priority level threshold U, then the resource R(x, y) will be excluded from the first resource set. The priority level threshold U and the quantity threshold T are configured by network or preconfigured or implemented by the terminal device or are each a value specified by the standard. Exemplarily, the priority level of data transmission of the second module is the priority level of data transmission of the second module on a group of periodic resources. Exemplarily, the second module indicates the priority level corresponding to each group of periodic resources to the first module. Optionally, in the case where the target resource includes multiple groups of periodic resources, the priority levels corresponding to any two groups of periodic resources may be the same or different. Any group of periodic resources in the target resource consists of periodic resources having the same frequency-domain location and different time-domain locations with a second resource reservation period as an interval. The second resource reservation period is a resource reservation period corresponding to the second module. Exemplarily, the second module indicates one or more groups of periodic resources included in the target resource to the first module.

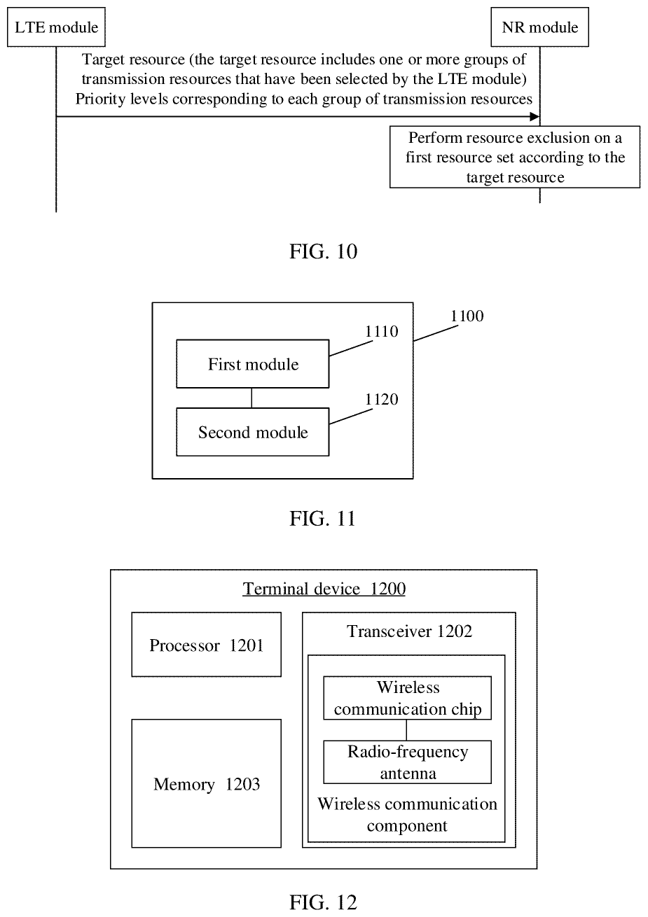

For example, as shown in FIG. 10, the LTE module indicates a target resource to the NR module, the target resource includes one or more groups of transmission resources that have been selected by the LTE module, and each group of transmission resources is a periodic resource having the same frequency-domain location with a second resource reservation period as an interval. The second resource reservation period is a resource reservation period corresponding to the LTE module. The NR module determines a resource selection window, and the first resource set is a set consisting of remaining resources obtained after the first, second and third exclusion steps are performed on the set consisting of all available resources in the resource selection window. For any resource R(x, y) in the first resource set, if the resource R(x, y) or a series of periodic resources (including the resource R(x, y)) corresponding to the resource R(x, y) overlaps with any group of transmission resources that has been selected by the LTE module in time domain, then the resource R(x, y) will be excluded from the first resource set.

For another example, as shown in FIG. 10, the LTE module indicates a target resource to the NR module, the target resource includes one or more groups of transmission resources that have been selected by the LTE module, and each group of transmission resources is a periodic resource having the same frequency-domain location with a second resource reservation period as an interval. The second resource reservation period is a resource reservation period corresponding to the LTE module. Moreover, the LTE module indicates the priority level corresponding to each selected group of transmission resources to the NR module, that is, the priority level of data transmission of the LTE module on each selected group of transmission resources is indicated to the NR module. The NR module determines a resource selection window, and the first resource set is a set consisting of remaining resources obtained after the first, second and third exclusion steps are performed on the set consisting of all available resources in the resource selection window. For any resource R(x, y) in the first resource set, if the resource R(x, y) or a series of periodic resources (including the resource R(x, y)) corresponding to the resource R(x, y) overlaps with any group of transmission resources that has been selected by the LTE module in time-domain, and the priority level of the LTE module transmitting on the group of transmission resources is higher than the priority level of data transmission of the NR module, then the resource R(x, y) will be excluded from the first resource set.

In this embodiment, the LTE module no longer indicates information such as the resource reservation period and the quantity of periods to the NR module, the LTE module indicates one or more groups of periodic resources directly to the NR module, so that the NR module no longer needs to determine the periodic resource according to information such as the resource reservation period and the quantity of periods.

The following are apparatus embodiments of the present application, which can be used to perform embodiments of method of the present application. For details not disclosed in the apparatus embodiments of the present application, reference is made to the method embodiments of the present application.

Reference is made to FIG. 11, which shows a block diagram of a resource exclusion apparatus provided by an embodiment of the present application. The apparatus has the function of implementing the above method examples, and the function may be achieved by hardware or by hardware executing corresponding software. The apparatus may be the terminal device described above, or may be provided in the terminal device. As shown in FIG. 11, the apparatus 1100 may include a first module 1110 and a second module 1120.

The first module 1110 is configured to perform resource exclusion according to a target resource, and the target resource is a transmission resource of the second module 1120, the first module 1110 and the second module 1120 are two different communication modules.

In some embodiments, the transmission resource of the second module is a selected resource of the second module; alternatively, the transmission resource of the second module is a scheduled resource of the second module.

In some embodiments, the target resource includes one or more resources.

In some embodiments, the target resource includes one or more groups of periodic resources.

In some embodiments, the target resource is indicated to the first module by the second module.

In some embodiments, the target resource includes one or more groups of periodic resources, the second module 1120 is further configured to indicate one or more resources to the first module 1110, and the first module 1110 is further configured to determine the one or more groups of periodic resources according to the one or more resources indicated by the second module 1120.

In some embodiments, the second module 1120 is further configured to indicate a resource reservation period corresponding to the second module 1120 to the first module 1110, and/or the second module 1120 is further configured to indicate a quantity of periods of at least one of the resources to the first module 1110, and the quantity of periods of the resource is used to determine a group of periodic resources corresponding to the resource.

In some embodiments, the target resource includes one or more groups of periodic resources, and the second module 1120 is further configured to indicate the one or more groups of periodic resources to the first module 1110.

In some embodiments, the first module 1110 and the second module 1120 are perform transmission on the same carrier.

In some embodiments, the first module 1110 is configured to perform resource exclusion on a first resource set according to the target resource.

In some embodiments, the first resource set includes all available resources in a resource selection window; alternatively, the first resource set includes available resources in part of time units in a resource selection window.

In some embodiments, the first resource set includes remaining resources obtained after at least one resource exclusion step is performed on all available resources in the resource selection window; alternatively, the first resource set includes remaining resources obtained after at least one resource exclusion step is performed on available resources in part of time units in the resource selection window.

In some embodiments, the at least one resource exclusion step includes at least one of the following:
a first exclusion step used to perform resource exclusion according to monitored first sidelink control information;
a second exclusion step used to perform resource exclusion according to monitored second sidelink control information; or
a third exclusion step used to perform resource exclusion according to unmonitored time unit(s);
where the first sidelink control information and the second sidelink control information are two different pieces of sidelink control information.

In some embodiments, the first sidelink control information is sidelink control information monitored by the first module 1110, and the second sidelink control information is sidelink control information monitored by the second module 1120.

In some embodiments, the first module 1110 is configured to: for a first resource in the first resource set, in response that the first resource meets an exclusion condition, exclude the first resource from the first resource set, where the exclusion condition includes the first resource or a periodic resource corresponding to the first resource overlapping with the target resource.

In some embodiments, the first resource or the periodic resource corresponding to the first resource overlapping with the target resource includes: the first resource or the periodic resource corresponding to the first resource overlapping with any resource in the target resource; or the first resource or the periodic resource corresponding to the first resource overlapping with any group of periodic resources in the target resource.

In some embodiments, in the case where the first resource or the periodic resource corresponding to the first resource overlaps with any group of periodic resources in the target resource, the exclusion condition further includes: a quantity of resources overlapping being greater than or equal to a quantity threshold.

In some embodiments, the exclusion condition further includes a priority level of data transmission of the second module 1120 being higher than a priority level of data transmission of the first module 1110 and/or higher than a priority level threshold.

In some embodiments, the priority level of data transmission of the second module 1120 is a priority level of data transmitted by the second module 1120 on the target resource.

In some embodiments, the second module 1120 is further configured to indicate the priority level of data transmission of the second module 1120 to the first module 1110.

In some embodiments, the periodic resource corresponding to the first resource includes: a periodic resource including the first resource, having the same frequency-domain location as the first resource and having time-domain locations with a resource reservation period corresponding to the first module 1110 as an interval.

In some embodiments, the first module 1110 is an NR module, and the second module 1120 is an LTE module or an E-UTRA module.

It should be noted that when the apparatuses provided by the above embodiments implement their functions, the division of functional modules described above is only used as an example. In practical application, the above functions can be implemented by assigning the functions to different functional modules according to actual needs. That is, the content structures of the apparatuses can be divided into different functional modules to complete all or part of the functions described above.

With regard to the apparatuses in the above embodiments, the specific manner in which the various modules perform the operations has been described in detail in the embodiments relating to the methods and will not be explained in detail here. For details not described in detail in the apparatus embodiments, reference may be made to the method embodiments described above.

Reference is made to FIG. 12, which is a structural diagram of a terminal device provided by an embodiment of the present application. The terminal device 1200 may include: a processor 1201, a transceiver 1202, and a memory 1203.

The processor 1201 includes one or more processing cores, the processor 1201 performs various functional applications and information processing by running software programs and modules.

The transceiver 1202 may include a receiver and a transmitter. For example, the receiver and the transmitter may be implemented as a same wireless communication component, and the wireless communication component may include a wireless communication chip and a radio-frequency antenna.

The memory 1203 may be connected to the processor 1201 and the transceiver 1202.

The memory 1203 may be configured to store computer programs executed by the processor, and the processor 1201 is configured to execute the computer programs to perform various step in the above method embodiments.

In some embodiments, the processor 1201 has the function of controlling the first module and the second module in the terminal device 1200. As for the description of the first module and the second module, reference may be made to other embodiments above and will not be repeated here. Optionally, the processor 1201 is configured to control the first module to perform resource exclusion according to the target resource, where the target resource is a transmission resource of the second module; the first module and the second module are two different communication modules.

For details not described in detail in this embodiment, reference is made to the above embodiments, which will not be repeated here.

In addition, the memory may be implemented by any type of volatile or non-volatile storage device or a combination thereof, and the volatile or non-volatile storage device include but is not limited to, magnetic disk storage, optical disc, electrically erasable programmable read-only memory (EEPROM), erasable programmable read-only memory (EPROM), static random-access memory (SRAM), read-only memory (ROM), magnetic memory, flash memory, or programmable read-only memory (PROM).

Embodiments of the present application also provide a non-transitory computer-readable storage medium having stored thereon a computer program. The computer program is configured to be executed by a processor to implement the resource exclusion method above. Optionally, non-transitory the computer-readable storage medium may include a read-only memory (ROM), a random access memory (RAM), a solid state drives (SSD), an optical disk, and the like. The random access memory includes a resistive random access memory (ReRAM) and a dynamic random access memory (DRAM).

Embodiments of the present application provide a chip, which includes a programmable logic circuitry and/or program instructions. When the chip is running, the chip is configured to implement the above-mentioned resource exclusion method.

Embodiments of the present application provide a computer program product or a computer program, the computer program product or the computer program contains computer instructions, the computer instructions are stored on a non-transitory computer-readable storage medium, and a processor reads and executes the computer instructions from the non-transitory computer-readable storage medium to implement the above-mentioned resource exclusion method.

It should be understood that “indication” involved in embodiments of the present application may be a direct indication, may be an indirect indication, or may represent an association relationship. As an example, that A indicates B may mean that A indicates B directly, for example, B can be acquired through A; or it may mean that A indicates B indirectly, for example, A indicates C, and B can be acquired through C; or it may mean that there is an association between A and B.

In the description of the embodiments of the present application, the term “correspond” may mean that there is a directly corresponding or an indirectly corresponding relationship between two parties, or mean that there is an association between two parties, or mean a relationship such as indicating and being indicated, or configuring and being configured.

In embodiments of the present application, “pre-defined” may be achieved by pre-storing a corresponding code, a table, or other modes that may be used to indicate related information in a device (e.g., including the terminal device and the network device), and its specific implementation is not limited in the present application. For example, pre-defined may refer to what is defined in a protocol.

In an embodiments of the present application, the “protocol” may refer to a standard protocol in the communication field, for example, may include an LTE protocol, an NR protocol, and a related protocol applied in a future communication system, which are not limited in the present application.

The term “multiple” in the present application may be two or more. The term “and/or” describes the association relationship between associated objects, and means that there can be three kinds of relationships. For example, A and/or B, can mean that there are three situations. That is, only A exists, A and B exist at the same time, and only B exists. The character “/” generally indicates that the related objects are of an “or” relationship.

The term “greater than or equal to” involved in the present application may mean greater than or equal to or more than, and “less than or equal to” may mean no more than or less than.

In addition, the numbers of the operations described in the present application only represents a possible sequence of implementation between the operations by example, and in some other embodiments, the above-mentioned operations may also be performed not in the sequence. For example, two differently numbered operations are performed simultaneously, or two differently numbered operations are performed in a sequence reverse to the illustration, which is not limited in the embodiments of the present application.

Those skilled in the art will appreciate that, in one or more of the above examples, the functions described in the embodiments of the present application may be implemented in hardware, software, firmware or any combination thereof. When the functions are implemented in software, these functions may be stored in a computer-readable medium or transmitted as one or more instructions or codes on the computer-readable medium. The computer-readable medium includes a non-transitory computer storage medium and a communication medium. The communication medium includes any medium that facilitates the transfer of computer programs from one place to another place. The non-transitory storage medium may be any available medium accessible to a general-purpose or special-purpose computer.

The above descriptions are only exemplary embodiments of the present application and are not intended to limit the present application. Any modification, equivalent replacement, improvement or the like made within the spirit and principles of the present application shall fall within the scope of protection of the present application.

What is claimed is:

1. A resource exclusion method applied to a terminal device comprising a first module and a second module, the method comprising:
performing, by the first module, resource exclusion according to a target resource, wherein the target resource is a transmission resource of the second module, and the first module and the second module are two different communication modules.

2. The method according to claim 1, wherein
the transmission resource of the second module is a selected resource of the second module; or
the transmission resource of the second module is a scheduled resource of the second module.

3. The method according to claim 1, wherein the target resource comprises one or more resources.

4. The method according to claim 1, wherein the target resource comprises one or more groups of periodic resources.

5. The method according to claim 1, wherein the target resource is indicated to the first module by the second module.

6. The method according to claim 1, wherein the first module and the second module perform transmission on a same carrier.

7. The method according to claim 1, wherein performing, by the first module, resource exclusion according to the target resource, comprising:
performing, by the first module, resource exclusion on a first resource set according to the target resource.

8. The method according to claim 7, wherein
the first resource set comprises remaining resources obtained after at least one resource exclusion step is performed on all the available resources in the resource selection window; or
the first resource set comprises remaining resources obtained after at least one resource exclusion step is performed on the available resources in part of time units in the resource selection window.

9. The method according to claim 8, wherein the at least one resource exclusion step comprises at least one of the following:
a first exclusion step used to perform resource exclusion according to monitored first sidelink control information;
a second exclusion step used to perform resource exclusion according to monitored second sidelink control information; or
a third exclusion step used to perform resource exclusion according to unmonitored time unit(s);
wherein the first sidelink control information and the second sidelink control information are two different pieces of sidelink control information.

10. The method according to claim 7, wherein performing, by the first module, resource exclusion on the first resource set according to the target resource, comprising:
for a first resource in the first resource set, in response that the first resource meets an exclusion condition, excluding, by the first module, the first resource from the first resource set, wherein the exclusion condition comprises: the first resource or a periodic resource corresponding to the first resource overlapping with the target resource.

11. The method according to claim 10, wherein the first resource or the periodic resource corresponding to the first resource overlapping with the target resource, comprising:
the first resource or the periodic resource corresponding to the first resource overlapping with any resource in the target resource; or
the first resource or the periodic resource corresponding to the first resource overlapping with any group of periodic resources in the target resource.

12. The method according to claim 10, wherein the exclusion condition further comprises: a priority level value of data transmission of the second module being less than a priority level value of data transmission of the first module and/or less than a priority level threshold.

13. The method according to claim 12, wherein the priority level value of the data transmission of the second module is a priority level value of data transmitted by the second module on the target resource.

14. The method according to claim 12, wherein the method further comprises:
indicating, by the second module, the priority level value of data transmission of the second module to the first module.

15. The method according to claim 1, wherein the first module is a new radio (NR) module, and the second module is a long term evolution (LTE) module or an evolved universal terrestrial radio access (E-UTRA) module.

16. A terminal device comprising a processor and a memory, wherein the memory stores a computer program thereon, and the processor executes the computer program to cause a first module of the terminal device to perform:
performing resource exclusion according to a target resource, wherein the target resource is a transmission resource of a second module of the terminal device, and the first module and the second module are two different communication modules.

17. The terminal device according to claim 16, wherein
the transmission resource of the second module is a selected resource of the second module; or
the transmission resource of the second module is a scheduled resource of the second module.

18. The terminal device according to claim 16, wherein the target resource comprises one or more resources; or
the target resource comprises one or more groups of periodic resources.

19. The terminal device according to claim 16, wherein the target resource is indicated to the first module by the second module.

20. A non-transitory computer-readable storage medium, having a computer program stored thereon, wherein the computer program is used to be executed by a processor to cause a first module of a terminal device to perform:
performing resource exclusion according to a target resource, wherein the target resource is a transmission resource of a second module of the terminal device, and the first module and the second module are two different communication modules.
